(19) United States
(12) Patent Application Publication
(10) Pub. No.: US 2010/0229716 A1
(43) Pub. Date: Sep. 16, 2010

(54) CONCENTRIC SLAVE CYLINDER

(75) Inventor: Jeremy Govan, Hinkley (GB)

Correspondence Address: CHERNOFF, VILHAUER, MCCLUNG & STENZEL, LLP, 601 SW Second Avenue, Suite 1600, PORTLAND, OR, 97204-3157, US

(73) Assignee: AP RACING LIMITED, Coventry (GB)

(21) Appl. No.: 12/715,225

(22) Filed: Mar. 1, 2010

(30) Foreign Application Priority Data
Mar. 7, 2009 (GB) 0903984.3

(51) Int. Cl. F16D 25/12; F16J 10/02; F16J 9/12

(52) U.S. Cl. 92/169.1

(57) ABSTRACT

A concentric slave cylinder for a clutch has a housing 12 with a through bore 16. An annular piston 26 is movably disposed in the bore 16 and a release bearing 46 is mounted to the piston. At least at least part of the bore 16 has a non-circular shape in lateral cross-section and the piston 26 has a correspondingly shaped outer periphery so as to be non-rotatable but axially moveable in bore. The non-circular portion of the bore 16 and the outer periphery of the piston 26 may be elliptical or they may be shaped to define three, four or more lobes 72.

This invention relates to concentric clutch slave cylinders for motor vehicles.

It is known to provide hydraulic slave cylinders for controlling the engagement and disengagement of a friction clutch in a motor vehicle. In some applications it is advantageous to mount the slave cylinder concentrically about an input shaft of the vehicle gearbox and these are known generally as concentric slave cylinders.

Known concentric slave cylinders typically comprise an annular housing which surrounds the gearbox input shaft and which is mounted to the vehicle, usually the gearbox casing or the engine, so that it is restrained from rotation. An annular piston is movably mounted in a bore in the housing and carries a clutch release bearing. The piston and housing define a hydraulic chamber between them into which hydraulic fluid can be introduced under pressure to effect movement of the piston. Hydraulic seals are operative between the housing and the piston to prevent the hydraulic fluid from leaking.

In so-called push type clutches, the bearing may directly contact the release levers of an associated clutch. In this arrangement, movement of the piston in response to a driver depressing a clutch pedal moves the bearing towards the clutch so as to push the leavers to disengage the clutch. In a so-called pull type clutch, the bearing may carry a release sleeve having a fulcrum which engages behind the release leavers. In this arrangement, movement of the piston in response to a driver depressing a clutch pedal draws the release bearing and the release sleeve away from the clutch so that the release sleeve pulls the levers to disengage the clutch.

In normal use with engine running, the clutch release levers rotate and the clutch release bearing isolates the piston and the housing from the rotary movement of the levers. However, no bearing is completely effective and some torque is applied to the piston, particularly during disengagement and engagement of the clutch. This toque has to be resisted or the piston will rotate in the housing severely reducing the life of the hydraulic seals, the piston and the body.

In some known concentric slave cylinders, rotation of the piston is resisted by using square section hydraulic seals mounted with a high seal fill ratio to generate a high load between the piston and the housing. This produces a high level of hysteresis between the parts preventing rotation of the piston. This hysteresis is, however, not a desirable feature as increased loads are required at the pedal to operate the clutch, reducing pedal feel and hence clutch control.

In one known attempt to overcome this problem, pins are mounted to the slave cylinder housing for sliding engagement with the piston to prevent it from rotating in the housing. This arrangement is effective at preventing the piston from rotating and enables o-ring hydraulic seals to be used with a lower fill ratio so reducing the level of hysteresis. However, the design is complex and includes additional components, adding to the cost of manufacture. In addition, this arrangement is not feasible in all applications where packaging limitations may preclude its use.

It is an object of the invention to provide an improved or alternative form of concentric slave cylinder which overcomes, or at least mitigates, some or all of the disadvantages of the known arrangements.

In accordance with the invention, there is provided a concentric slave cylinder comprising a housing having a bore, an annular piston movably disposed in the bore and a release bearing mounted to the piston, in which at least part of the bore has a non-circular shape in lateral cross-section and the piston has a correspondingly shaped outer periphery so as to be non-rotatable but axially moveable in bore.

The non-circular portion of the bore may be elliptical or it may be shaped to define three, four or more lobes.

The cylinder may have one or more o-ring type hydraulic seals operative between the piston and the housing.

The bore may be a stepped bore having first portion with a larger cross-sectional area and a second portion with a smaller cross-sectional area and the piston may be correspondingly stepped to have a first piston portion dimensioned for engagement with the first portion of the bore and a second piston portion dimensioned for engagement with the second portion of the bore. Both portions of the bore may be non-circular in lateral cross-section and both piston portions may have a correspondingly shaped outer profile non-rotatably received in their respective portions of the bore. The cylinder may have a first o-ring hydraulic seal operative between the first portion of the piston and the housing and a second o-ring hydraulic seal operative between the second portion of the piston and the housing. The first o-ring seal may be located in a groove in the outer periphery of the first piston portion for contact with a surface of the housing defining the first portion of the bore. The second o-ring seal may be located in a groove in the surface of the housing defining the second portion of the bore for contact with an outer surface of the second piston portion.

A release sleeve may be mounted to the bearing for engagement with the release levers of an associated clutch.

An embodiment of the invention will now be described, by way of example only, with reference to the accompanying drawings, in which:

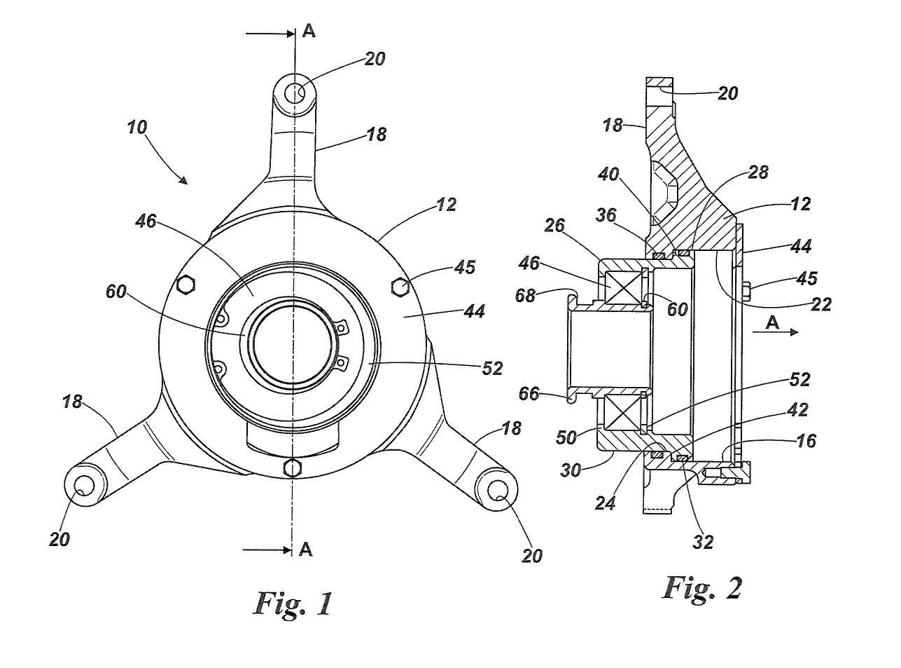

FIG. 1 is an end elevation of a concentric slave cylinder in accordance with the invention;

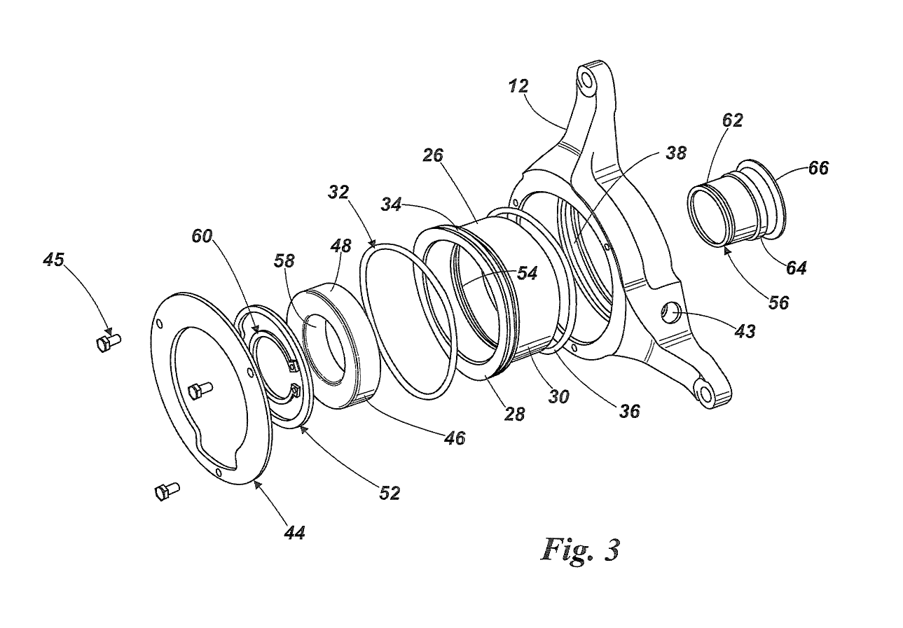

FIG. 2 is a longitudinal cross-sectional view through the cylinder of FIG. 1, taken on line A-A;

FIG. 3 is an exploded view of the cylinder of FIGS. 1 and 2, and

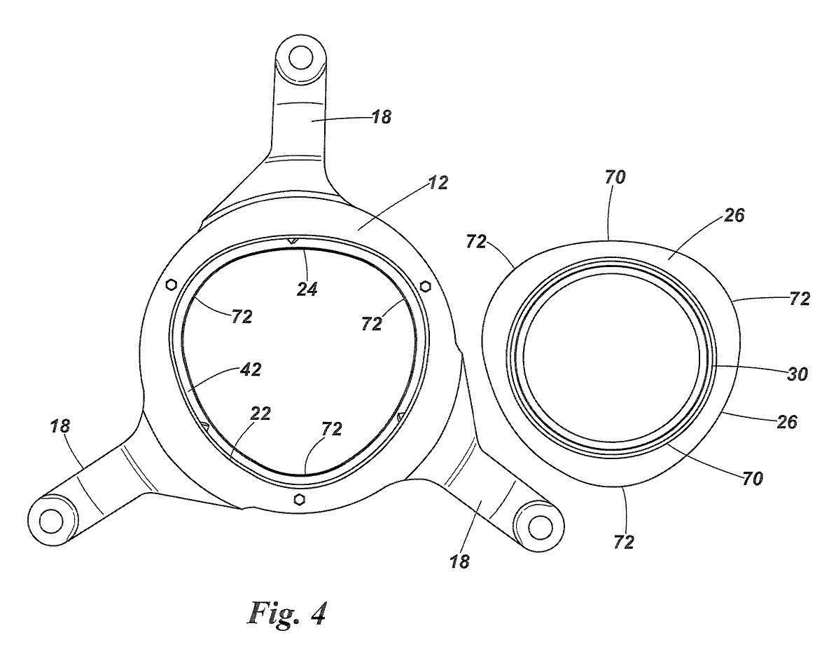

FIG. 4 shows end elevations of a housing and a piston forming part of the cylinder of FIGS. 1 to 4 side by side.

A concentric clutch slave cylinder 10 in accordance with the invention comprises a housing 12 having an annular main body portion 14 defining a through bore 16. Three mounting lugs 18 project radially outwardly from the main body portion 14. Holes 20 are provided at outer end regions of the lugs 18 to receive suitable fasteners, such as bolts or studs (not shown), for mounting the housing 12 to part of a vehicle. Although not shown in the drawings, the housing 12 will typically be mounted to part of a gearbox housing or to the engine of a vehicle so as to surround an input shaft of the gearbox in a known manner.

The bore 16 is a stepped bore having a first portion 22 with a larger cross-sectional area and a second portion 24 having a smaller cross-sectional area. The first portion 22 of the bore is longer in an axial direction of the cylinder than the second portion 24. An annular piston 26 is slidably mounted in the bore. The piston has a first portion 28 which is dimensioned to be a close sliding fit in first portion 22 of the bore 16 and a second portion 30 which is dimensioned to be a close sliding fit in the second portion 24 of the bore. The second portion 30 of the piston is longer in an axial direction of the cylinder than the first piston portion 28.

A first hydraulic oil seal 32 is located in a groove 34 in the outer surface of the first piston portion 28 for sealing engagement which the surface of the first portion 22 of the bore 16. A second hydraulic oil seal 36 is located in a groove 38 in the surface of the housing which defines the second portion 24 of the bore and contacts the outer surface of the second portion 30 of the piston. A hydraulic chamber 40 is defined in the first portion 22 of the bore between the first portion 28 of the piston and a step 42 in the housing between the first and second portions 22, 24 of the bore. The housing 12 has an inlet 43 to which a hydraulic line from a brake master cylinder can be connected. The inlet is fluidly connected with the chamber 40 so that hydraulic fluid can be introduced into the chamber under pressure from the master cylinder line when an associated clutch pedal, or other actuating means, operatively connected with the master cylinder is depressed. The introduction of hydraulic fluid into the chamber 40 moves the piston 26 axially in the direction indicated by arrow A in FIG. 2 relative to the housing to disengage an associated clutch. A plate 44 is mounted to the housing by means of bolts 45 at the open end of the first bore portion 22 to limit movement of the piston 26 in the direction of arrow A and to prevent the piston 26 from disengaging with the bore 16.

A clutch release bearing 46 is mounted to an inner surface of the piston. The release bearing 46 is a ball race type bearing and has an outer race 48 held in abutment with a lip 50 on the piston by means of a circlip 52 which engages in a groove 54 in the inner surface of the piston. The concentric slave cylinder 10 of the present embodiment is configured for use with a pull type clutch and has an annular release sleeve 56 mounted to an inner race 58 of the bearing 46 by means of a further circlip 60. The further circlip 60 locates in a groove 62 in the outer surface of the sleeve to hold the inner race in contact with a ridge 64 on the outer surface of the sleeve. The sleeve 56 has a lip 66 which locates behind the release levers (typically diaphragm spring fingers) of an associated clutch. The lip 66 has a fulcrum 68 which contacts the inner surfaces of the levers.

In operation, when a driver depresses the clutch pedal of vehicle to which the cylinder 10 is fitted, hydraulic fluid is introduced in to the chamber 40 under pressure. This moves the piston 26 axially in the direction of arrow A in FIG. 2 from an initial, clutch disengaged position (as shown), towards a fully actuated position in which the piston 26 is closer to and possibly in contact with the plate 44. As the piston moves in the direction of arrow A, the lip 66 on the release sleeve 56 pulls the release levers against the bias of a clutch spring from a clutch engaged position to disengage the clutch, with the release levers pivoting about the fulcrum 68. When the driver releases the clutch pedal, the clutch spring re-engages the clutch drawing the release levers back to their clutch engaged position. The levers act on the lip 66 of the release sleeve 56 to move the release sleeve 56 and the piston 26 in a direction opposite to that indicated by arrow A back to the clutch disengaged position. As the piston 26 is retracted, the hydraulic fluid in the chamber 40 is displaced back into the hydraulic line and the master cylinder.

As so far described, the concentric slave cylinder is largely conventional. However, as can best be seen from FIG. 4, in accordance with the invention the bore 16 has a non-circular shape when viewed in lateral cross-section. The outer periphery 70 of the piston 26 where it engages in the bore 16 has a complementary non-circular profile so that the piston 26 is prevented from rotating within bore 16 whilst being able to slide in an axial direction.

Because the piston 26 is prevented from rotating by the complementary non-circular shapes of the bore 16 and the piston 26, the hydraulic seals 32, 36 can be simple o-ring seals which make a point or line contact with the surface they seal against and a standard seal fill ratio can be achieved in the piston and housing. This means that there is reduced level of hysteresis between the housing and the piston when compared to the known concentric slave cylinders using square profile seals with a high seal fill ratio. Furthermore, no additional components are required to prevent the piston 26 from rotating so that manufacturing and assembly costs are not significantly increased and the cylinder 10 in accordance with the invention can be packaged in the same volume as an equivalent conventional concentric slave cylinder which relies on square section seals and a high seal fill ratio to prevent rotation of the piston.

In the present embodiment, both the first and second portions 22, 24 of the bore 16 and the corresponding first and second portions 28, 30 of the piston have complementary non-circular shapes. However, in some embodiments, it may be possible that only part of the bore 16 has a non-circular shape and that only the outer periphery of a corresponding portion of the piston has a complementary non-circular shape.

Any suitable non-circular shape can be used for the bore 16 and the piston 26, provided an effective seal can be formed between them and provided the piston is able to move freely along the bore 16. For example, the bore 16 and the piston 26 could have an elliptical shape or, as in the present embodiment, they may be shaped to have three or more equi-spaced lobes 72. The provision of three lobes as shown is thought to be particularly advantageous as it spreads the load evenly about the piston but is not unduly complex to manufacture. As shown, the lobes 72 may be positioned between the mounting lugs 18 on the housing. Advantageously, the non-circular geometry of the piston and bore is configured to enable the use of standard circular o-ring seals.

Whilst the invention has been described in relation of a concentric slave cylinder for a pull type clutch, the invention is equally applicable to concentric slave cylinders for use with push type clutches and the invention can be applied regardless of the arrangements for actuating the cylinder. For use with a push type clutch, the release bearing will be typically mounted to the piston so that it can be brought directly into contact with the release levers of an associated clutch to disengage the clutch.

Whereas the invention has been described in relation to what is presently considered to be the most practical and preferred embodiment, it is to be understood that the invention is not limited to the disclosed arrangements but rather is intended to cover various modifications and equivalent constructions included within the spirit and scope of the invention.

1. A concentric slave cylinder comprising a housing having a bore, an annular piston movably disposed in the bore and a release bearing mounted to the piston, in which at least part of the bore has a non-circular shape in lateral cross-section and the piston has a correspondingly shaped outer periphery so as to be non-rotatable but axially moveable in bore.

2. A concentric slave cylinder as claimed in claim 1, in which the non-circular portion of the bore is elliptical.

3. A concentric slave cylinder as claimed in claim 1, in which the non-circular portion is shaped to define three or more lobes.

4. A concentric slave cylinder as claimed in any one of the preceding claims, in which one or more o-ring type hydraulic seals are operative between the piston and the housing.

5. A concentric slave cylinder as claimed in claim 1, in which the bore is a stepped bore having first portion with a larger cross-sectional area and a second portion with a smaller cross-sectional area and the piston is correspondingly stepped to have a first piston portion dimensioned for engagement with the first portion of the bore and a second piston portion dimensioned for engagement with the second portion of the bore.

6. A concentric slave cylinder as claimed in claim 5, in which both portions of the bore are non-circular in lateral cross-section and both piston portions have a correspondingly shaped outer profile non-rotatably located in their respective portions of the bore.

7. A concentric slave cylinder as claimed in claim 6, in which a first o-ring hydraulic seal is operative between the first portion of the piston and the housing and a second o-ring hydraulic seal is operative between the second portion of the piston and the housing.

8. A concentric slave cylinder as claimed in 7, in which the first o-ring seal is located in a groove in the outer periphery of the first piston portion for contact with a surface of the housing defining the first portion of the bore.

9. A concentric slave cylinder as claimed in claim 7 or claim 8, in which the second o-ring seal may is located in a groove in the surface of the housing defining the second portion of the bore for contact with an outer surface of the second piston portion.

10. A concentric slave cylinder as claimed in claim 1, in which a release sleeve is mounted to the bearing for engagement with the release levers of an associated clutch.
